(19) United States
(12) Patent Application Publication
(10) Pub. No.: US 2026/0217370 A1
(43) Pub. Date: Jul. 30, 2026

(54) COLLAPSIBLE PARTITION

(71) Applicant: Gulfstream Aerospace Corporation, Savannah, GA (US)

(72) Inventors: Sean Thornton, Savannah, GA (US); Brian Tolar, Savannah, GA (US); Jayson Luke Cary, Savannah, GA (US)

(73) Assignee: Gulfstream Aerospace Corporation, Savannah, GA (US)

(21) Appl. No.: 19/038,899

(22) Filed: Jan. 28, 2025

(51) Int. Cl. B64D 11/00

(52) U.S. Cl. CPC B64D 11/0023

(57) ABSTRACT

A collapsible partition includes first and second foldable bodies, and first and second substrate arrays. The first body has a planar configuration when unfolded and it includes a plurality of primary substrates, each having a flat geometric shape and being resistant to folding, and each coupled to the inward-facing side of the first body. The second body has a planar configuration when unfolded. The second substrate array is coupled to the first substrate array and includes a plurality of secondary substrates. Each secondary substrate has a flat geometric shape and is resistant to folding, and each secondary substrate is coupled to the inward-facing side of the second body. Compression of a substrate array causes the first substrate array to fold between at least some of the plurality of primary substrates, and contemporaneously causes the second substrate array to fold between at least some of the plurality of secondary substrates.

### TECHNICAL FIELD

The present invention relates generally to partitions and more particularly to partitions used to divide space occupied by people.

### BACKGROUND

Conventional partitions, such as those used to separate one room or chamber from another, or such as those used to divide an undivided space into divided space take a wide variety of forms. For example, conventional partitions include pivoting doors, pocket doors, swinging doors, metal bulkheads, retractable walls, curtains, hide-a-walls, and the like.

In a conventional aircraft interior, metal bulkheads affixed to opposite walls of a tubular aircraft cabin are commonly used in combination with curtains to separate one portion of an aircraft cabin from an adjacent portion to form separate compartments. Metal bulkheads consume floorspace and add weight to the aircraft. They are immovable and must be accounted for when formulating a floorplan for the aircraft's furniture and other accoutrements. Fabric curtains hanging between the bulkheads are heavy and lack an aesthetically pleasing appearance.

Accordingly, it is desirable to provide a partition that addresses the concerns expressed above. Furthermore, other desirable features and characteristics will become apparent from the subsequent summary and detailed description and the appended claims, taken in conjunction with the accompanying drawings and the foregoing technical field and background.

### BRIEF SUMMARY

Various non-limiting embodiments of a partition are disclosed herein.

In a first non-limiting embodiment, the partition includes, but is not limited to, a first body that comprises a foldable material. The first body has a first side and a second side. The first body has a planar configuration when unfolded. The partition further includes, but is not limited to, a plurality of substrates. Each substrate of the plurality of substrates has a flat geometric shape and is resistant to folding. The partition further includes, but is not limited to, an adhesive. Each substrate of the plurality of substrates is adhered to the second side of the first body by the adhesive and is arranged in a repeating pattern that defines a plurality of columns and a plurality of rows. Each column of the plurality of columns is spaced apart from each neighboring column to define a plurality of longitudinally extending gaps between columns. Each row of the plurality of rows is spaced apart from each neighboring row to define a plurality of laterally extending gaps between rows. The first body is configured to fold in a lateral direction along the plurality of longitudinally extending gaps in an accordion-like manner and to contemporaneously fold in a longitudinal direction along the plurality of laterally extending gaps between rows in the accordion-like manner. The partition contracts both laterally and longitudinally when the first body contemporaneously folds in both the lateral direction and the longitudinal direction. The partition extends both laterally and longitudinally when the first body contemporaneously unfolds in both the lateral direction and the longitudinal direction.

In another non-limiting embodiment, the partition includes, but is not limited to, a first body that comprises a foldable material. The first body has a first side and a second side. The first body has a planar configuration when unfolded. The partition further includes, but is not limited to a plurality of substrates. Each substrate of the plurality of substrates has a flat geometric shape and is resistant to folding. The partition further includes, but is not limited to a second body that comprises a decorative, foldable material. The second body has the planar configuration when unfolded. The partition further includes, but is not limited to a third body that comprises the decorative, foldable material. The third body has the planar configuration when unfolded. The partition still further includes, but is not limited to an adhesive. Each substrate of the plurality of substrates is adhered to the second side of the first body by the adhesive and arranged in a repeating pattern defining a plurality of columns and a plurality of rows. Each column of the plurality of columns is spaced apart from each neighboring column to define a plurality of longitudinally extending gaps between columns. Each row of the plurality of rows is spaced apart from each neighboring row to define a plurality of laterally extending gaps between rows. The second body is adhered to the first side of the first body by the adhesive. The third body is adhered to the second side of the first body and to a back side of the plurality of substrates by the adhesive. The first body and the second body and the third body are configured to fold in a lateral direction along the plurality of longitudinally extending gaps in an accordion-like manner and to contemporaneously fold in a longitudinal direction along the plurality of laterally extending gaps between rows in the accordion-like manner. The partition contracts both laterally and longitudinally when first body, the second body, and the third body contemporaneously fold in both the lateral direction and the longitudinal direction. The partition extends both laterally and longitudinally when the first body, the second body, and the third body contemporaneously unfold in both the lateral direction and the longitudinal direction.

In accordance with another non-limiting embodiment, a collapsible partition includes: a first body having a foldable material; a first substrate array; a second body having a foldable material; and a second substrate array. The first body has an inward-facing side and an outward-facing side, and the first body has a planar configuration when unfolded. The first substrate array includes a plurality of primary substrates. Each primary substrate has a flat geometric shape and is resistant to folding, and each primary substrate is coupled to the inward-facing side of the first body. The second body has an inward-facing side and an outward-facing side, and the second body has a planar configuration when unfolded. The substrate array is coupled to the first substrate array and it includes a plurality of secondary substrates. Each secondary substrate has a flat geometric shape and is resistant to folding, and each secondary substrate is coupled to the inward-facing side of the second body. Compression of the first substrate array or the second substrate array in a longitudinal or lateral dimension causes the first substrate array to fold between at least some of the plurality of primary substrates, and contemporaneously causes the second substrate array to fold between at least some of the plurality of secondary substrates.

In accordance with another non-limiting embodiment, a collapsible partition includes: a first body having a foldable material; a first substrate array including a plurality of primary substrates; a second body having a foldable material; and a second substrate array coupled to the first substrate array and including a plurality of secondary substrates. The first body has an inward-facing side and an outward-facing side, and the first body has a planar configuration when unfolded. Each primary substrate has a flat geometric shape and is resistant to folding, and each primary substrate is coupled to the inward-facing side of the first body. The second body has an inward-facing side and an outward-facing side, and the second body has a planar configuration when unfolded. Each secondary substrate has a flat geometric shape and is resistant to folding, and each secondary substrate is coupled to the inward-facing side of the second body. The the first and second substrate arrays are coupled together in an initial arrangement such that: the first substrate array is compressed in a longitudinal dimension and/or in a lateral dimension, with the plurality of primary substrates defining an initially folded state for the first substrate array; and the second substrate array is uncompressed, with the plurality of secondary substrates defining an unfolded state for the second substrate array.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The present invention will hereinafter be described in conjunction with the following drawing figures, wherein like numerals denote like elements, and

FIG. 1 is a perspective view illustrating a non-limiting example of a vehicle suitable for use with non-limiting embodiments of a partition made in accordance with the teachings disclosed herein;

FIG. 2 is a perspective view illustrating an interior of the vehicle of FIG. 1 equipped with a non-limiting example of the partition made in accordance with the teachings disclosed herein, the partition being disposed in a closed configuration;

FIG. 3 is a perspective view similar to FIG. 2 with the partition disposed in a partially open configuration;

FIG. 4 is a perspective view similar to FIG. 3 with the partition disposed in a fully open configuration;

FIG. 5 is an exploded view of the partition of FIGS. 2-4;

FIG. 6 is a perspective view illustrating a non-limiting example of a support layer of the partition of FIGS. 2-4;

FIG. 7 is a perspective view of a non-limiting example of a substrate of the partition of FIGS. 2-4;

FIG. 8 is a perspective view illustrating the multiple substrates of FIG. 7 coupled with the support layer of FIG. 6;

FIG. 9 is a perspective view similar to FIG. 2 where the interior of the vehicle is equipped with an alternate non-limiting embodiment of a partition made in accordance with the teachings of the present disclosure, the partition disposed in a closed configuration;

FIG. 10 is a perspective view similar to FIG. 9 with the partition disposed in a fully open configuration;

FIG. 11 is an exploded schematic view of another embodiment of a partition that is suitable for use in the environments shown in FIGS. 2-4, 9, and 10;

FIG. 12 is a diagram that depicts arrangements of primary and secondary substrates suitable for use with the partition shown in FIG. 11;

FIG. 13 shows an arrangement of the primary substrates in detail;

FIG. 14 shows an arrangement of the secondary substrates in detail;

FIG. 15 is a plan view that shows one secondary substrate overlying one primary substrate;

FIG. 16 is a perspective view that depicts primary substrates in a compressed/folded state, and arranged to cooperate with secondary substrates in an uncompressed/flat state;

FIG. 17 is a perspective view that depicts the primary substrates in an intermediate compressed/folded state, and arranged to cooperate with the secondary substrates in a compressed/folded state; and

FIG. 18 is a perspective view that depicts the primary substrates in a final compressed/folded state, and arranged to cooperate with the secondary substrates in a final compressed/folded state.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

An improved partition is disclosed herein. The partition of the present disclosure is configured to fold and unfold between an open and a closed position. Whereas a conventional curtain or foldable partition is configured to fold in an accordion-like fashion in only a single direction (e.g., laterally), the partition of the present disclosure is configured to fold in two directions, both laterally and longitudinally. Furthermore, the partition of the present disclosure is configured to do so contemporaneously. This is accomplished through the use of multiple layers, at least one layer of which comprises a plurality of substrates that are constructed from a material that is resistant to folding and a second layer which is suitable for folding. Each substrate of the plurality of substrates has the same size and shape and each is affixed to the second layer via an adhesive. The plurality of substrates are arranged in a spaced-apart pattern that creates both rows and columns. In a non-limiting example, the pattern is a herringbone pattern. The second layer is configured to fold in an accordion-like manner contemporaneously along both the rows and the columns. Accordingly, when folded contemporaneously along the rows and columns, the partition contracts both laterally and longitudinally. Conversely, when unfolded along the rows and columns, the partition extends both laterally and longitudinally.

A greater understanding of the partition discussed above may be obtained through a review of the illustrations accompanying this application together with a review of the detailed description that follows.

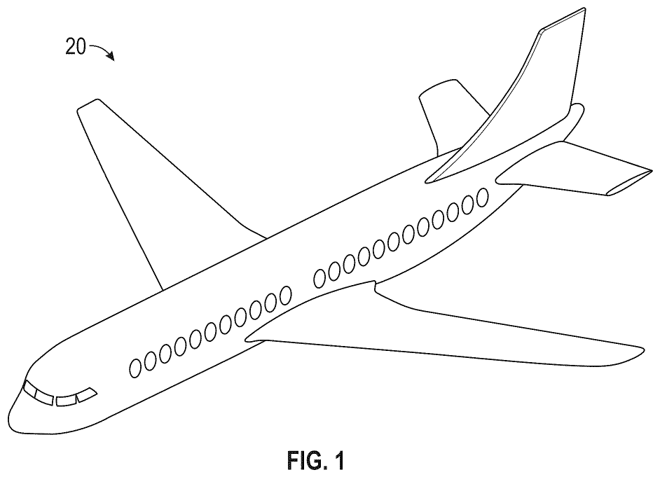

FIG. 1 is a perspective view of a non-limiting example of a vehicle 20 suitable for use with the partition disclosed herein. In the illustrated embodiment, vehicle 20 is depicted as aircraft. While the partition disclosed herein is compatible for use onboard an aircraft, it should be understood that the partition disclosed here is not limited to such use. Rather, the partition disclosed herein is compatible with all types of vehicles. Further, the partition disclosed herein is not limited to with vehicles. Rather, the partition disclosed herein may be used in any conceivable application that calls for the use of partitions to divide or close off spaces. For instance, and without limitation, the partition disclosed herein may be employed in domestic applications as an alternative to a swinging or pocket door. Further, the partition disclosed herein may be employed in office applications to serve as a means for dividing workstations into cubicles. In other embodiments, the partition of the present invention may be employed in any other application which calls for the use of a conventional partition.

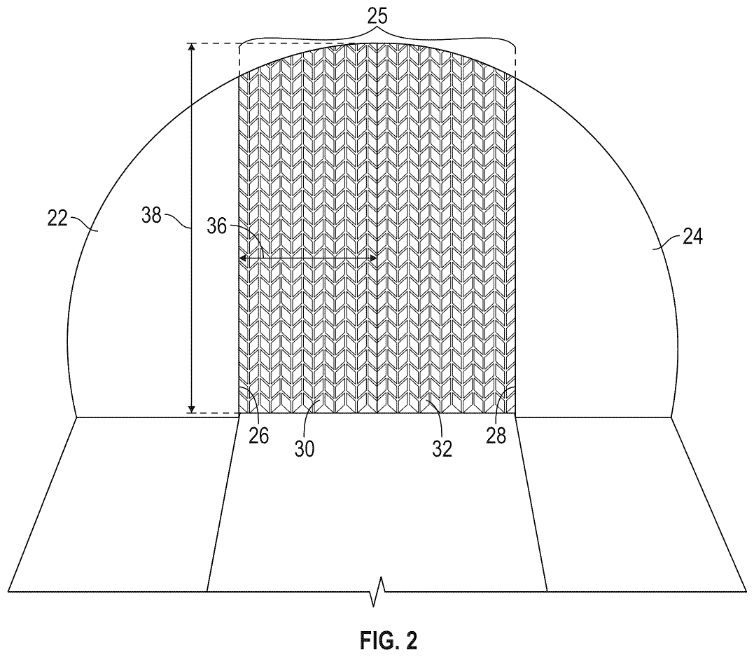

With continuing reference to FIG. 1, FIG. 2 is a perspective view illustrating an upstream or forward-looking longitudinal view of an interior of vehicle 20. Bulkhead 22 and bulkhead 24 extend from opposite interior walls of a cabin of vehicle 20. Bulkheads 22 and 24 extend laterally into a center portion of the cabin. A gap 25 is formed between an inboard edge 26 of bulkhead 22 and an inboard edge 28 of bulkhead 24. Closing off gap 25 is a partition 30 and a partition 32, each of which have been made in accordance with the teachings of the present disclosure. In another non-limiting embodiment, a single partition may be employed to span gap 25.

In the illustrated embodiment, partition 30 extends in an inboard direction from inboard edge 26 and partition 32 extends in an inboard direction from inboard edge 28. In FIG. 2, partition 30 and partition 32 are fully extended and meet in the middle to close off gap 25. In an example, the two partitions are held together in the middle of the cabin by any suitable coupling mechanism, including, but without limitation, by hook and loop connectors or by magnets. This configuration will be referred to herein alternately as the closed position or the extended position. When in the closed position, the upper peripheral contour of partition 30 and partition 32 are configured to have an arc that conforms to the circular interior contour of the ceiling of the cabin of vehicle 20. In other embodiments, any portion of the periphery of partition 30 and any portion of partition 32 may be contoured to conform to the curvature of the internal surface of any opening that partition 30 and partition are coupled with.

As illustrated in FIG. 2, partition 30 and partition 32 each have a decorative appearance that is aesthetically pleasing. In the illustrated embodiment, the decorative appearance comprises a herringbone pattern. As discussed in detail below, the herringbone pattern is not superficial or merely surface level, but rather, it runs throughout the entire structure of partitions 30 and 32. Partition 30 and partition 32 are each configured and trained to fold in an accordion-like fashion along the folds in the herringbone pattern. Specifically, each partition is configured to contemporaneously fold horizontally or laterally along a lateral axis 36, and to also fold vertically or longitudinally along a longitudinal axis 38. Being able to fold both horizontally and vertically in an accordion-like fashion has the effect of causing each partition to contract along both its length and height dimensions which, in turn, causes an increase in the width or thickness of each partition when folded or contracted. Although a herringbone pattern has been illustrated in FIG. 2 and throughout this disclosure, it should be understood that any other suitable repeating pattern that is effective to permit the contemporaneous folding of the partition in both a horizontal and vertical direction may also be employed without departing from the teachings of the present disclosure.

With continuing reference to FIGS. 1-2, FIG. 3 is a perspective view illustrating the upstream or forward-looking longitudinal view of the interior of vehicle 20 shown in FIG. 2 with partition 30 and partition 32 in a partially folded or contracted state. In the illustrated embodiment, partition 30 and partition 32 are mounted to inboard edge 26 and inboard edge 28, respectively, at a longitudinally central location along each partition. Consequently, in the illustrated embodiment, when partition 30 contracts, an upper end of partition 30 contracts vertically downwards from a ceiling of the cabin and a lower end of partition 30 contracts vertically upwards from a floor of the cabin. The same applies to partition 32.

In an alternate embodiment, partition 30 and partition 32 may be mounted to inboard edge 26 and inboard edge 28 at a vertically lower location along partition 30 and partition 32, respectively. In such an embodiment, partition 30 would contract longitudinally downward from a ceiling of the cabin while a lower portion of partition 30 would remain adjacent a floor surface of the cabin. Conversely, in yet another embodiment, partition 30 and partition 32 may be mounted to inboard edge 26 and inboard edge 28 at a vertically upper location along partition 30 and partition 32, respectively. In such an embodiment, partition 30 would contract longitudinally upward from a floor of the cabin.

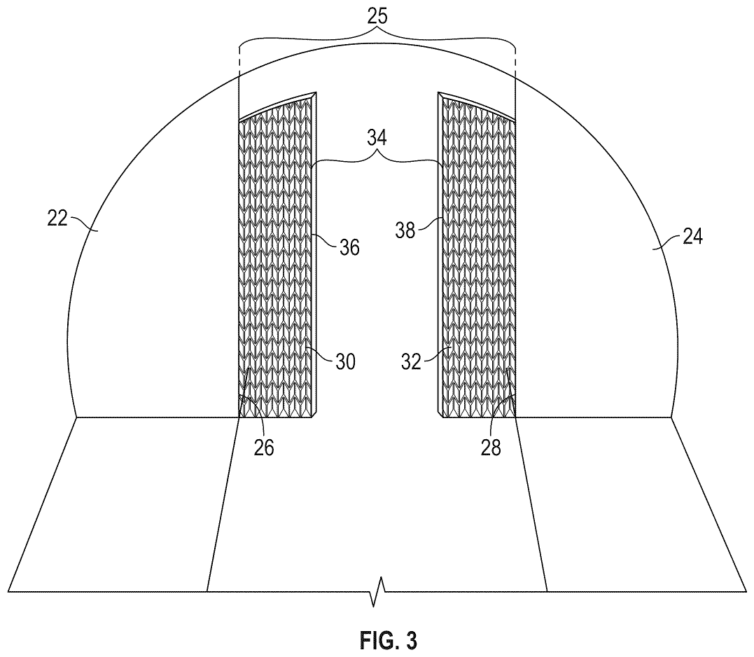

As illustrated in FIG. 3, with partition 30 and partition 32 in a partially contracted state, a gap 34 has formed present between an inboard edge of partition 30 and an inboard edge of partition 32. The magnitude of gap 34 can be controlled by a user by simply contracting partition 30 and partition 32 to a desired state of contraction. Gap 34 permits movement between two compartments of the cabin divided by partitions 30 and 32 while still providing some degree of separation between the two compartments. In an embodiment, partition 30 and partition 32 may comprise a magnet or a plurality of magnets that facilitate retaining partition 30 and partition 32 in their partially contracted states.

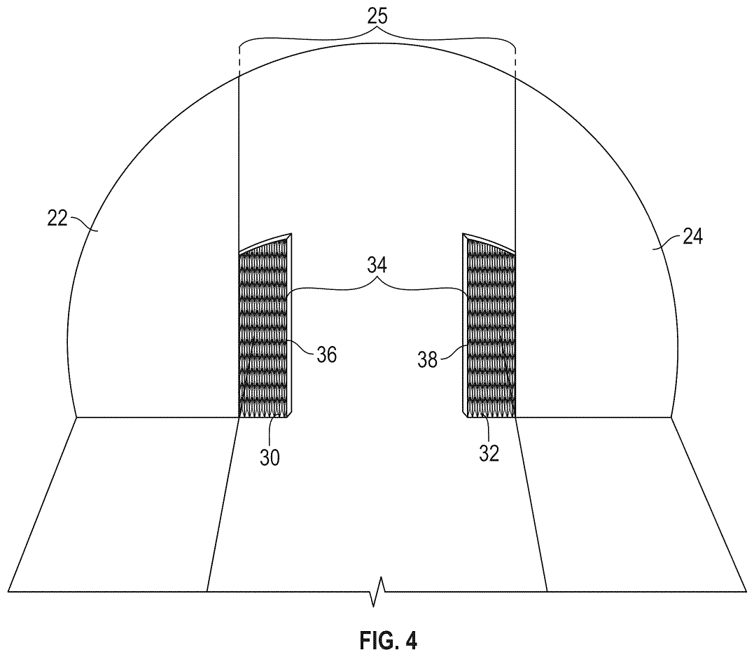

With continuing reference to FIGS. 1-3, FIG. 4 is a perspective view illustrating the upstream or forward-looking longitudinal view of the interior of vehicle 20 shown in FIGS. 2 and 3 with partition 30 and partition 32 in a fully folded or contracted state. As illustrated in FIG. 4, with partition 30 and partition 32 in a fully contracted state, gap 34 has widened as compared with FIG. 3. In this fully folded or contracted state, partitions 30 and 32 have contracted both laterally and longitudinally as compared with their respective states as illustrated in FIG. 3. Also, when fully folded or contracted, gap 34 permits the greatest degree of access and movement between the two compartments of the cabin that are divided by partitions 30 and 32. This configuration will be referred to herein alternately as the open position or the retracted position. As discussed above, in an embodiment, partition 30 and partition 32 may comprise a magnet or a plurality of magnets that facilitate retaining partition 30 and partition 32 in their fully contracted states.

With continuing reference to FIGS. 1-4, FIG. 5 is an exploded view of partition 30. In the illustrated embodiment, partition 30 and partition 32 are substantially identical. Consequently, the description provided below of the exploded view of partition 30 applies equally to partition 32.

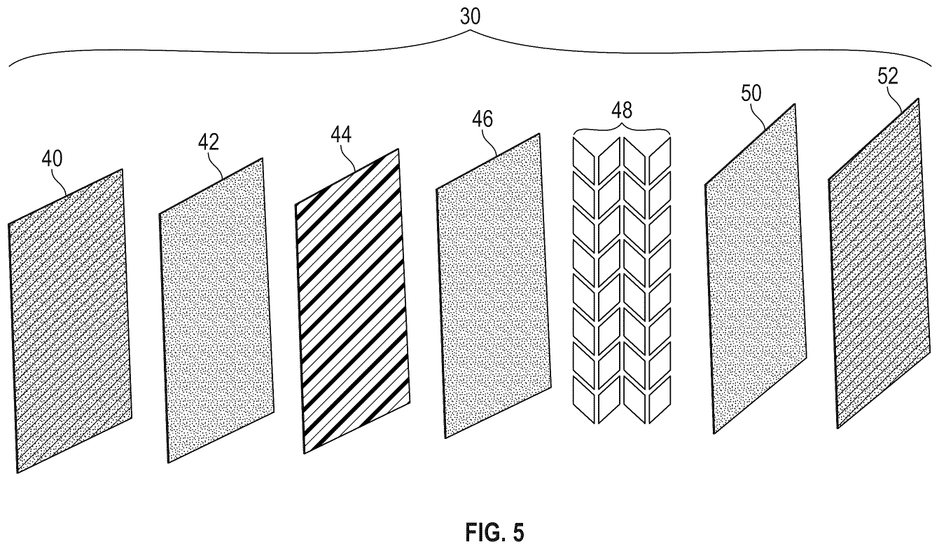

The embodiment of partition 30 illustrated in FIG. 5 includes a decorative layer 40, an adhesive layer 42, a support layer 44, an adhesive layer 46, a plurality of substrates 48, an adhesive layer 50, and a decorative layer 52. In other embodiments, a greater or lesser number of layers may be employed without departing from the teachings of the present disclosure.

Decorative layer 40 and decorative layer 52 each comprise any suitably decorative material that is capable of being folded. In an example, decorative layer 40 and decorative layer 52 may each comprise a leather material, a felt material, a vinyl material or vinyl material or printed 3D plastic, ABS or polymer.

Adhesive layer 42, adhesive layer 46, and adhesive layer 50 may comprise any material or substance having two-sided adhesiveness and that is effective to join two adjacent layers to one another. Adhesive layers 42, 46, and 50 may comprise a film adhesive or a liquid adhesive or a spray-on adhesive or any combinations thereof. In a non-limiting embodiment, adhesive layers 42, 46, and 50 are transparent. In another non-limiting embodiment, adhesive layers 42, 46, and 50 are at least partially translucent.

Support layer 44 may be comprised of any material capable of being folded. In a non-limiting example, support layer 44 may comprise a mylar material. In other embodiments, support layer 44 may comprise any other suitable material including, but not limited to vinyl material or printed 3D plastic, ABS or polymer.

Plurality of substrates 48 comprise a plurality of individual substrates, each having a geometric configuration that comprises a constituent part of the decorative repeating pattern of partition 30. In the non-limiting illustrated embodiment, each substrate has a substantially identical geometric configuration. The geometric configuration of each individual substrate 48 is such that, when they are positioned proximate one another in a spaced apart relationship and arranged and oriented in the manner indicated in FIG. 5, then in the aggregate, plurality of substrates 48 and the spaces between them form the herringbone pattern illustrated in FIG. 2. In a non-limiting example, each individual substrate 48 has a diamond configuration. In other embodiments, any other geometric configuration that is effective to form an overall pattern that supports contemporaneous lateral/horizontal and longitudinal/vertical folding may be employed without departing from the teachings of the present disclosure.

Each substrate 48 is comprised of a material that is resistant to folding. In an example, substrate 48 may be comprised of a plexiglass material. In other embodiments, plurality of substrates 48 may be comprised of any other suitable material that is resistant to folding and that is capable of taking on and maintaining a desired geometric configuration. Examples of such material include, but are not limited to vinyl material or printed 3D plastic, ABS or polymer.

When assembled, the various layers of partition 30 are sandwiched together, with adhesive layers disposed between adjacent non-adhesive layers to form an integrated, composite body of disparate, layered materials (referred to herein as the “partition body”). All layers except for the plurality of substrates 48 are capable of folding. Because the plurality of substrates 48 are arranged on support layer 44 in a spaced apart manner, there is space between neighboring substrates 48 to permit the folding of each of the other layers along those spaces.

Once the partition body has been formed, it must then be “trained”. As used herein, the term “trained” refers to the process of pre-folding the partition body in a predetermined manner that permits the partition body to contemporaneously fold laterally/horizontally and longitudinally/vertically. An example of how to train a material having a herringbone pattern is illustrated in a YouTube video which can be accessed by conducting a search using the title “Origami Herringbone Tessellation Tutorial”, the contents of which are hereby incorporated herein in their entirety by reference. Accordingly, the process of training/folding a sheet of material to impart a herringbone pattern to that sheet of material is well known in the art.

Once the partition body has been trained, it may be cut or otherwise given a contour that will conform to the dimensions, contour, and configuration of the opening that it will be fitted to. In an embodiment, the partition body may be cut or otherwise given the appropriate contour prior to undertaking the training process. Once the partition body has been trained and contoured, it is ready for service as partition 30. The training process not only permits the partition to contemporaneously fold both laterally and longitudinally, but it also creates a creased appearance in the surface of the partition of the repeating pattern. It is the creased appearance that gives rise to the decorative appearance of the partition. In the illustrated embodiment, the creased appearance is a herringbone pattern. In other embodiments, any other suitable pattern that permits contemporaneous folding in both the lateral and longitudinal directions may be employed without departing from the teachings of the present disclosure.

With continuing reference to FIGS. 1-5, FIG. 6 is a perspective view illustrating support layer 44. In the illustrated embodiment, support layer 44 has a herringbone pattern printed on its surface. Adhesive layer 46 is transparent or sufficiently translucent to permit the printed herringbone pattern remain visible after adhesive layer 46 has been applied. This printing of the herringbone pattern coupled with the use of a transparent or translucent adhesive facilitates the application and positioning of each substrate of plurality of substrates 48 onto support layer 44. In another non-limiting embodiment, support layer 44 may comprise a decorative material, thereby eliminating the need for two separate layers to provide support and decorative roles.

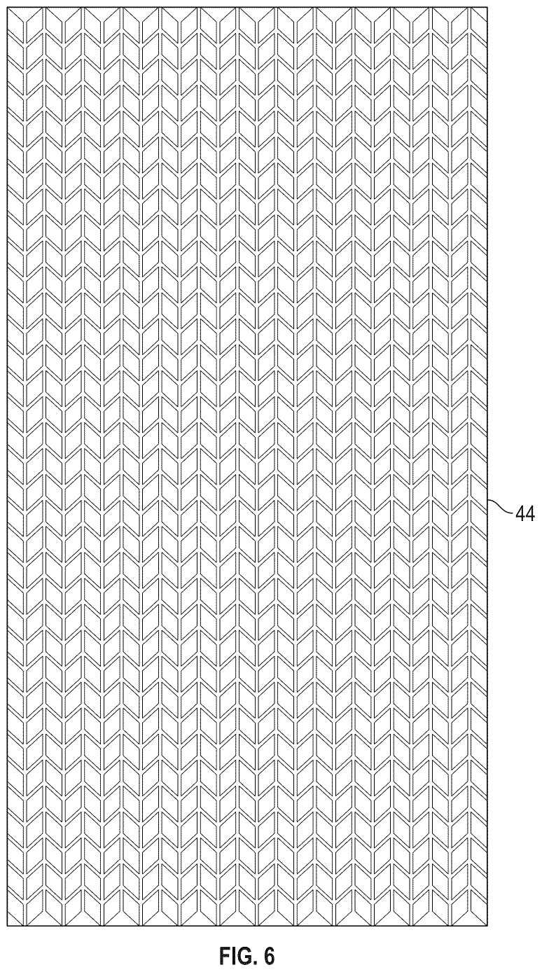

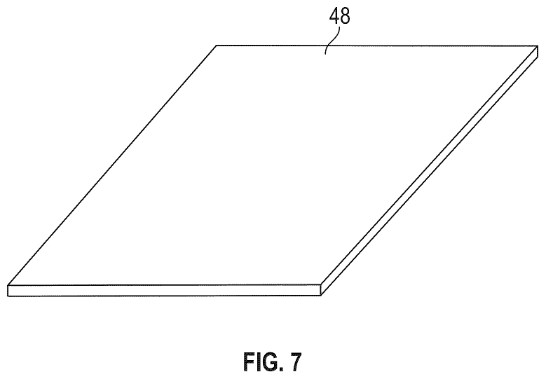

With continuing reference to FIGS. 1-6, FIG. 7 is a perspective view of a non-limiting example of substrate 48. In the illustrated embodiment, substrate 48 has a diamond configuration. This diamond configuration fits within the pattern printed on the surface of support layer 44 shown in FIG. 6 and facilitates the creation of the herringbone pattern. In another embodiment that employs a differing pattern, substrate 48 will have a shape/contour/configuration that, when arranged together with other like-shaped substrate members, will form the differing pattern.

In the illustrated embodiment, substrate 48 is constructed of plexiglass. In other embodiments, substrate 48 may be constructed from any other suitable material that is resistant to folding. When plurality of substrates 48 are arranged and adhered to the surface of support layer 44, this resistance to folding will facilitate the training of the partition body. This is because each un-foldable substrate will be spaced apart from each other un-foldable substrate. This spaced-apart arrangement will leave a gap between individual substrates, both vertically and horizontally, that is bridged by the remaining layers of the partition body. Each of the remaining layers is comprised of a foldable material. A worker undertaking the training process will feel through the partition body with his or her hands for the relatively hard and unfoldable adjacent substrates 48. Once detected, the worker will know to fold the partition body between adjacent substrates 48. In this manner, substrates 48 serve as a guide for the training process.

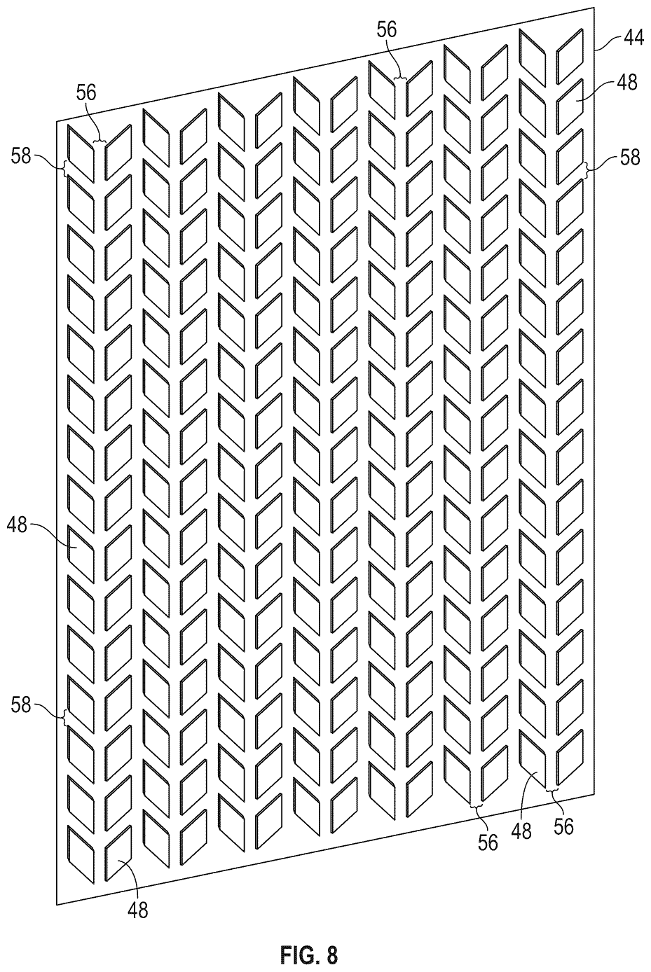

With continuing reference to FIGS. 1-7, FIG. 8 is a perspective view illustrating plurality of substrates 48 adhered to support layer 44 in a herringbone pattern. In this view, a plurality of longitudinal gaps 56 and a plurality of lateral gaps 58 are disposed between the columns and rows, respectively, formed by plurality of substrates 48. Longitudinal gap 56 and lateral gap 58 facilitate the training of the composite body of disparate layers, as discussed above.

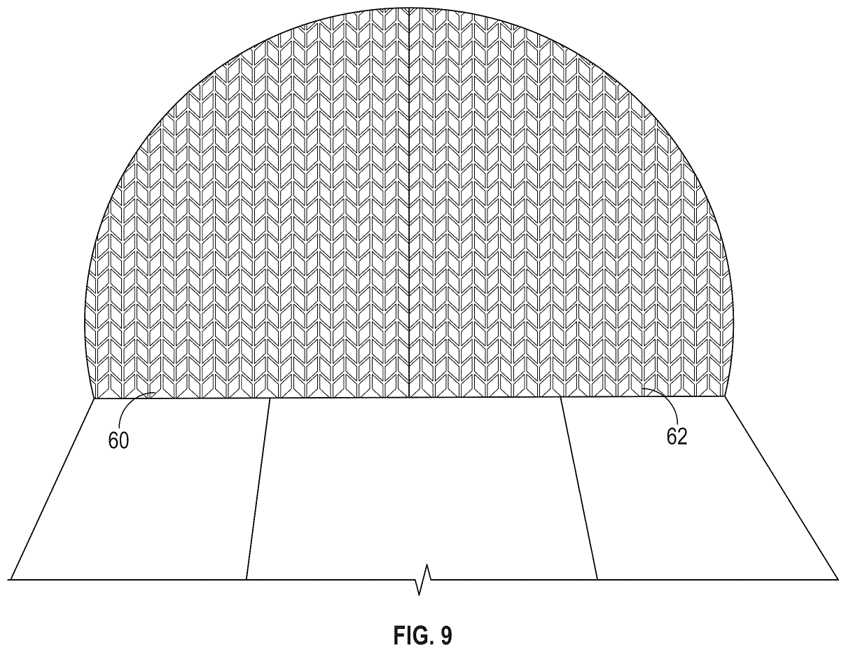

With continuing reference to FIGS. 1-8, FIG. 9 is a perspective view illustrating an interior of vehicle 20 similar to the view presented in FIG. 2. The primary difference between FIG. 2 and FIG. 9 is that in FIG. 9, the interior of vehicle 20 omits bulkhead 22 and bulkhead 24. Instead, a partition 60 and a partition 62 are used to divide the cabin of the vehicle 20 into separate chambers. Partition 60 and partition 62 are identical to partition 30 and partition 32, respectively, in all respects except for contours and dimensions. Partitions 60 and 62 have been given a contour and a dimension that permit each to conform to the interior surfaces of the cabin from wall to wall. In the embodiment illustrated in FIG. 9, partitions 60 and 62 are each coupled to lower portions of opposite walls of the cabin of the vehicle 20 and each extends from the opposite walls into a central portion of the cabin to meet in the middle. Their upper contours are configured to conform to the circular arc of the cabin's interior and their lower contours are configured to conform to the straight lines of the cabin's floor. As illustrated in FIG. 9, partitions 60 and 62 are in the extended or closed position. In this position, partitions 60 and 62 divide an otherwise continuous and contiguous chamber into two distinct chambers.

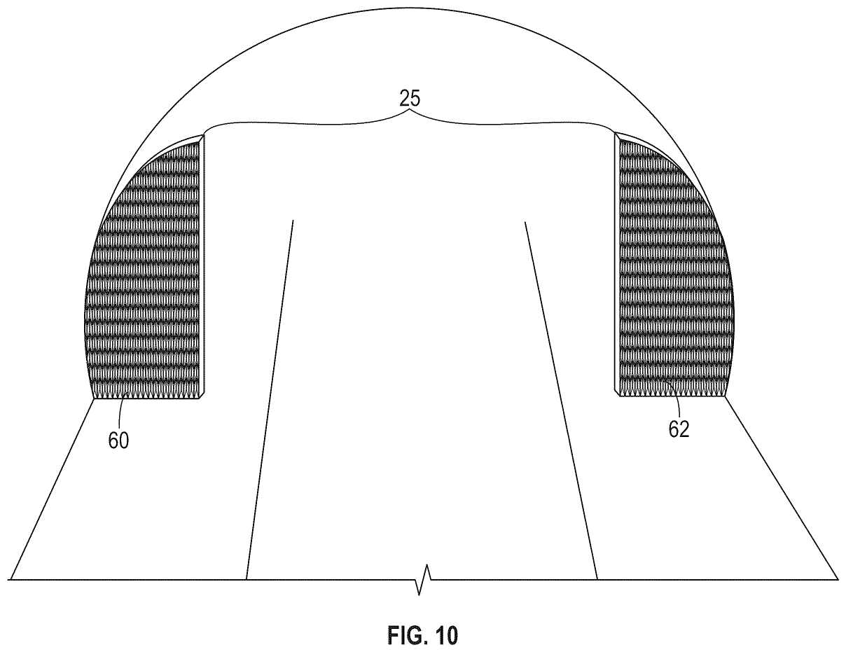

With continuing reference to FIGS. 1-9, FIG. 10 is a perspective view similar to FIG. 9 with partitions 60 and 62 disposed in a retracted or open position. Partition 60 and partition 62 have each contracted horizontally and vertically and have created gap 25 that permits movement between the adjoining chambers formed by partitions 60 and 62. In the illustrated embodiment, gap 25 is maximized. A user may partially close gap 25 by pulling partition 60 and partition 62 towards one another, thereby setting the magnitude of gap 25 to any desirable distance.

### Alternate Embodiment

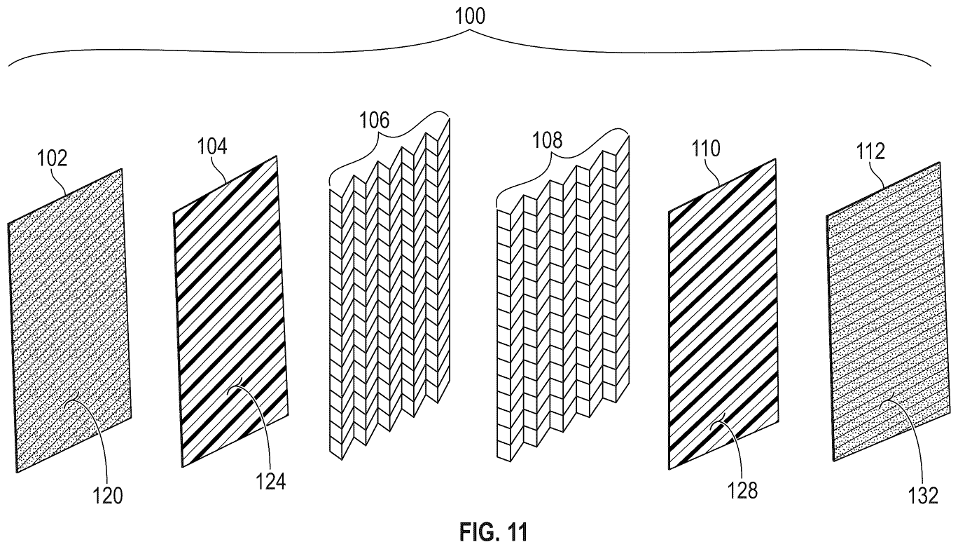

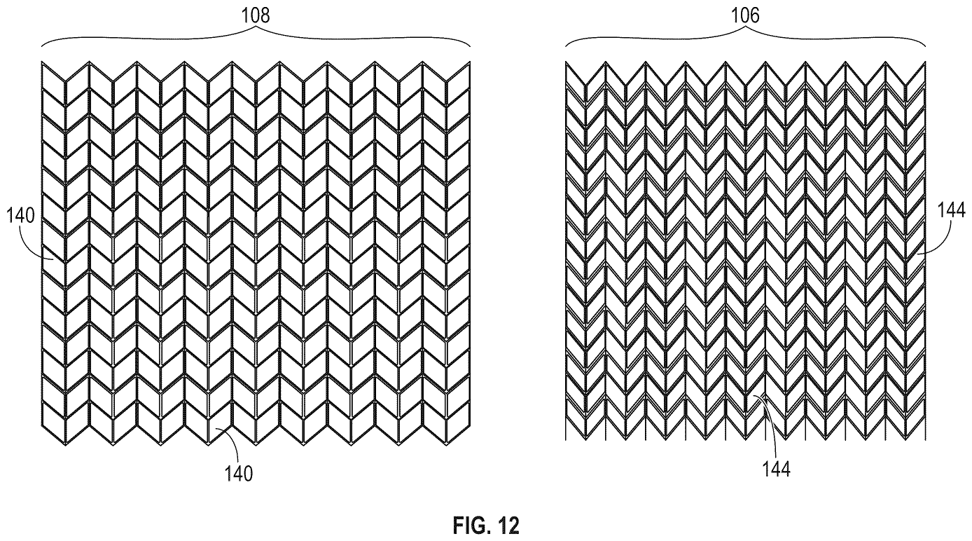

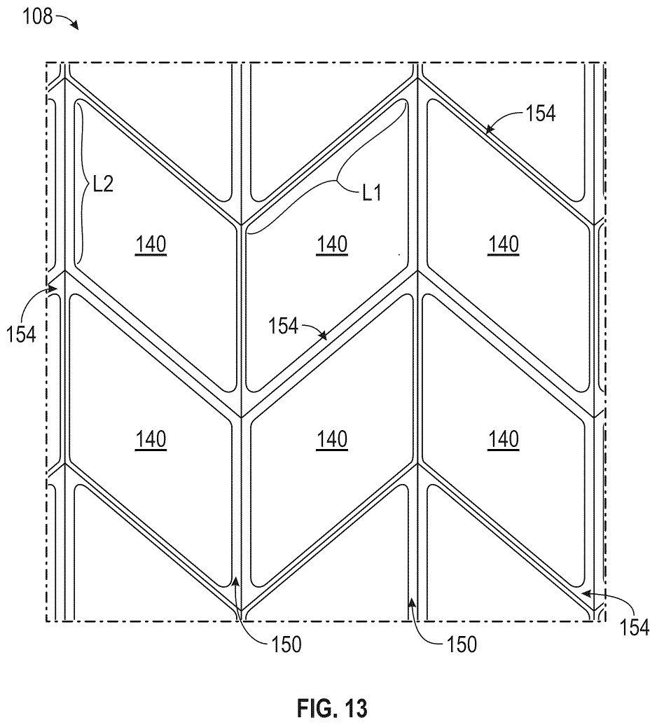

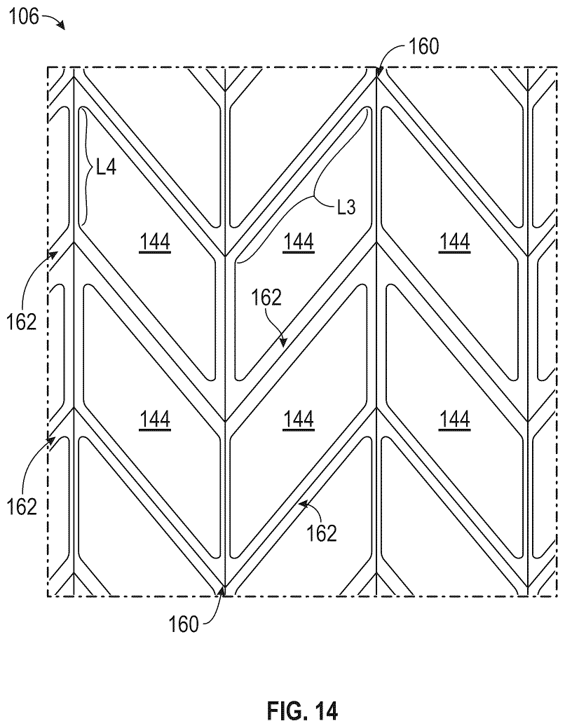

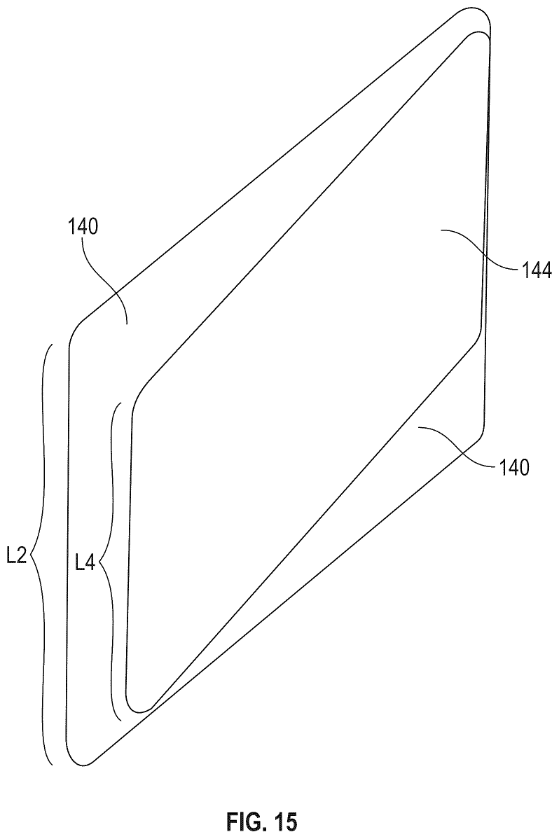

FIGS. 11-18 relate to a collapsible partition that includes at least two layers or arrays of rigid substrates, rather than a single layer as contemplated by the embodiments described above. FIG. 11 is an exploded schematic view of an exemplary embodiment of a collapsible partition 100 that can be shaped, sized, and configured for use in the environments shown in FIGS. 2-4, 9, and 10. FIG. 12 is a diagram that depicts arrangements of primary and secondary substrates suitable for use with the partition 100; FIG. 13 shows an arrangement of the primary substrates in detail; FIG. 14 shows an arrangement of the secondary substrates in detail; and FIG. 15 is a plan view that shows one secondary substrate overlying one primary substrate. Certain elements, features, and functionality associated with the partition 100 are identical, similar, or equivalent to those described above for the partitions 30, 32, 60, 62. Shared, common, or equivalent aspects will not be redundantly described in detail here with reference to the alternate embodiment(s).

Referring to FIG. 11, the illustrated embodiment of the partition 100 includes, without limitation: a decorative body 102; a support body 104; a substrate array 106; a substrate array 108; a support body 110; and a decorative body 112. For simplicity and ease of illustration, FIG. 11 does not depict any adhesive layers, adhesive material, bonding agent, or the like (in contrast to FIG. 5, which depicts three adhesive layers). The inward-facing side 120 of the decorative body 102 is coupled to the outward-facing side (hidden from view in FIG. 11) of the support body 104; the inward-facing side 124 of the support body 104 is coupled to the substrate array 106; the substrate arrays 106, 108 are coupled together; the substrate array 108 is coupled to the inward-facing side (hidden from view in FIG. 11) of the support body 110; and the outward-facing side 128 of the support body 110 is coupled to the inward-facing side (hidden from view in FIG. 11) of the decorative body 112. The various layers, bodies, materials, and components of the partition 100 can be coupled together in any appropriate manner, as described above with reference to the other embodiments.

Each decorative body 102, 112 includes or is formed from a decorative and foldable material. Although not always required, preferred embodiments use the same material or combination of materials for both decorative bodies 102, 112. The outward-facing side (hidden from view in FIG. 11) of the decorative body 102 serves as one major outer surface of the partition 100, while the outward-facing side 132 of the decorative body 112 serves as another major outer surface of the partition 100.

Each support body 104, 110 includes or is formed from a foldable material or combination of materials that exhibits a planar configuration when unfolded. In certain embodiments, each support body 104, 110 includes or is formed from a material or combination of materials having a naturally flat and unfolded state, i.e., the material or combination of materials tends to return to a flat/planar configuration when unloaded, uncompressed, unstretched, etc. Although not always required, preferred embodiments use the same material or combination of materials for both support bodies 104, 110. As mentioned above, the support bodies 104, 110 may include or be fabricated from MYLAR material, a vinyl material, a plastic material, acrylonitrile butadiene styrene (ABS), a polymer material, a composite structure, or the like.

For the depicted embodiment, the substrate array 108 is the primary substrate array of the partition 100, and the substrate array 106 is the secondary substrate array of the partition 100. The substrate array 108 includes a plurality of primary substrates 140 arranged in an appropriate manner, and the substrate array 106 includes a plurality of secondary substrates 144 arranged in an appropriate manner. Each primary substrate 140 is coupled to the inward-facing side (not labeled in FIG. 11) of the support body 110, and each secondary substrate 144 is coupled to the inward-facing side 124 of the support body 104.

The substrate array 108 may be identical or similar to the arrangement described above with reference to FIGS. 2-10. To this end, each primary substrate 140 has a flat geometric shape (e.g., an identically shaped and sized rhomboid), and each primary substrate 140 is resistant to folding, bending, or deforming under normal usage and environmental conditions. With reference to FIG. 13, the substrate array 108 includes longitudinally extending gaps 150 defined between adjacent columns of the primary substrates 140, and includes laterally extending gaps 154 defined between adjacent rows of the primary substrates 140. These gaps 150, 154 represent the spacing between physically distinct instances of the primary substrates 140. In this regard, the primary substrates 140 are arranged in a repeating pattern defining a plurality of columns (vertically oriented in FIGS. 11-13) and a plurality of rows (each row resembles a horizontally oriented zig-zag pattern - or a series of chevrons; see FIG. 12 and FIG. 13). Thus, each column of primary substrates 140 is spaced apart from each neighboring column of primary substrates 140 to define the longitudinally extending gaps between those columns. Likewise, each row of primary substrates 140 is spaced apart from each neighboring row of primary substrates 140 to define the laterally extending gaps between those rows. In accordance with the illustrated embodiment, the substrate array 108 can be visualized and interpreted as having a plurality of primary substrates 140 arranged in a repeating pattern of chevrons, wherein each chevron is formed from two side-by-side adjacent neighboring primary substrates 140.

The substrate array 106 may be realized in a similar manner as described above for the substrate array 108, but with differently shaped and/or differently sized substrates. Accordingly, each secondary substrate 144 has a flat geometric shape (e.g., an identically shaped and sized rhomboid), and each secondary substrate 144 is resistant to folding, bending, or deforming under normal usage and environmental conditions. With reference to FIG. 14, the substrate array 106 includes longitudinally extending gaps 160 defined between adjacent columns of the secondary substrates 144, and includes laterally extending gaps 162 defined between adjacent rows of the secondary substrates 144. These gaps 160, 164 represent the spacing between physically distinct instances of the secondary substrates 144. In this regard, the secondary substrates 144 are arranged in a repeating pattern defining a plurality of columns (vertically oriented in FIGS. 11, 12, and 14) and a plurality of rows (each row resembles a horizontally oriented zig-zag pattern—or a series of chevrons; see FIG. 12 and FIG. 14). Thus, each column of secondary substrates 144 is spaced apart from each neighboring column of secondary substrates 144 to define the longitudinally extending gaps between those columns. Likewise, each row of secondary substrates 144 is spaced apart from each neighboring row of secondary substrates 144 to define the laterally extending gaps between those rows. In accordance with the illustrated embodiment, the substrate array 106 can be visualized and interpreted as having a plurality of secondary substrates 144 arranged in a repeating pattern of chevrons, wherein each chevron is formed from two side-by-side adjacent neighboring secondary substrates 144.

FIG. 13 and FIG. 14 are drawn to scale (or substantially to scale for purposes of visual perception). As shown in FIG. 13 and FIG. 14, each primary substrate 140 has a first rhomboid shape, each secondary substrate 144 has a second rhomboid shape, wherein the first and second rhomboid shapes are different. For purposes of this description, the meaning of “rhomboid” is consistent with its conventional and well known geometrical definition: a parallelogram with two different edge lengths and no right angles. Referring to FIG. 13, the rhomboid shape used for the primary substrates 140 has a long edge length L1 and a short edge length L2. Referring to FIG. 14, the rhomboid shape used for the secondary substrates 144 has a long edge length L3 and a short edge length L4. In accordance with the exemplary embodiments presented here, the long edge length L1 is equal to the long edge length L3, and the short edge length L2 is longer than the short edge length L4.

FIG. 15 is a plan view that shows one secondary substrate 144 overlying one primary substrate 140. FIG. 15 shows the differences between the two rhomboid shapes, and clearly indicates that the short edge length L2 (of the primary substrate 140) is longer than the short edge length L4 (of the secondary substrate 144). As visually indicated in FIG. 15, the rhomboid shape of the primary substrate 140 defines a first area, the rhomboid shape of the secondary substrate 144 defines a second area, and the first area is greater than the second area. It should be noted that FIG. 15 presents an optical illusion in that the long edge lengths of the two substrates 140, 144 appear to be different—they are actually equal in length (or substantially equal for practical purposes and deployment with the collapsible partition 100).

As demonstrated by the comparison depicted in FIG. 15, the primary substrate 140 differs from the secondary substrate 144 in short edge length and angle, while sharing long edge length. In this exemplary configuration, as the difference in angle increases, the travel of the combined substrata will decrease while the rigidity of the structure will increase. In addition, the difference in the side lengths will also increase.

The specific dimensions used for the primary substrates 140 and the secondary substrates 144 (i.e., the edge lengths and the angles defined by the edges) can be chosen to accommodate the particular needs of the intended application and deployment environment. The dimensions influence: the size of the “pleats” created when the partition 100 is folded; the height of the peaks created when the partition 100 is folded; static characteristics of the partition 100; and dynamic characteristics of the partition 100.

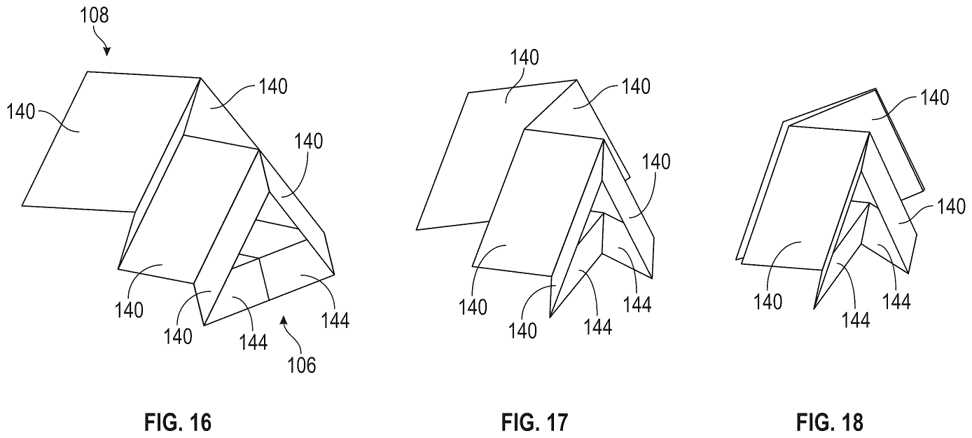

The substrate array 106 functions as a structural reinforcement layer that cooperates with the substrate array 108, both statically and dynamically. In practice, the substrate array 106 reduces unwanted sagging, bulging, warping, bending, and bowing of the collapsible partition 100, which might otherwise occur in the absence of the secondary substrates 144. The substrate array 106 is designed, arranged, and configured to provide additional rigidity and folding resistance to the partition 100. In certain embodiments, the substrate arrays 106, 108 are coupled together in an initial arrangement such that: (1) the substrate array 108 is compressed in a longitudinal dimension and/or in a lateral dimension, with the plurality of primary substrates 140 defining an initially folded, bent, or buckled state for the substrate array 108; and (2) the substrate array 106 is uncompressed, with the plurality of secondary substrates 144 defining an initially unfolded, flat, or unbuckled state for the substrate array 106. More specifically, when in the initial arrangement, the substrate array 106 is unfolded and flat (or substantially unfolded and substantially flat) and positioned underlying the substrate array 108, which is folded by at least some amount relative to its flattened condition. In this regard, FIG. 16 is a perspective view that depicts primary substrates 140 in a compressed/folded state, and arranged to cooperate with secondary substrates 144 in an uncompressed/flat state. In contrast, FIG. 17 is a perspective view that depicts the primary substrates 140 in an intermediate compressed/folded state, and arranged to cooperate with the secondary substrates 144 in a compressed/folded state, and FIG. 18 is a perspective view that depicts the primary substrates 140 in a final compressed/folded state, and arranged to cooperate with the secondary substrates 144 in a final compressed/folded state.

Referring to FIG. 14 (which corresponds to a plan view of the substrate array 106 in its unfolded condition), when the substrate arrays 106, 108 are in the initial arrangement and are viewed from this plan view perspective (i.e., a viewing angle that is perpendicular to the plane defined by the substrate arrays 106, 108 when they are flat and unfolded), the longitudinally extending gaps 150 of the substrate array 108 align with counterpart longitudinally extending gaps 160 of the substrate array 106, and the laterally extending gaps 154 of the substrate array 108 align with counterpart laterally extending gaps 162 of the substrate array 106. In other words, the plan view projection of the outlines of the primary substrates 140 will match the outlines of the underlying secondary substrates 144, and the plan view projection of the layout and arrangement of the gaps in the substrate array 108 will match the layout and arrangement of the gaps in the underlying substrate array 106. In reality, the gaps and seams between the secondary substrates 144 will not be visible because the substrate array 108 covers the substrate array 106. Nonetheless, FIG. 14 is intended to provide a visual reference that corresponds to the initial arrangement, for purposes of this description.

The layout, arrangement, and alignment of the primary and secondary substrates 140, 144 facilitate effective and efficient operation of the partition 100 (folding and unfolding). In this regard, compression of the substrate array 106 and/or the substrate array 108 in a longitudinal or lateral dimension causes the substrate array 108 to fold between at least some of the primary substrates 140, and contemporaneously causes the substrate array 106 to fold between at least some of the secondary substrates 144 in the same folding mode or in accordance with the same folding mechanics. As mentioned above, the primary substrates 140 are “pre-loaded” into an initially folded or buckled state (see FIG. 16), wherein the initial buckling direction corresponds to the positive height dimension away from the planar surface that is defined by the flat and unfolded substrate array 106. FIG. 17 and FIG. 18 illustrate how the primary substrates 140 continue to fold and buckle further in response to further compression of the substrate arrays 106, 108. FIG. 17 shows how the secondary substrates 144 have transitioned from the flat and unfolded state to a folded and buckled state. FIG. 18 shows the secondary substrates 144 in a further buckled state. For this example, FIG. 18 is considered to be the final compressed/folded state of the substrate arrays 106, 108.

As mentioned above with reference to the embodiment that utilizes only one substrate array, the support body 110 is configured to fold in a lateral direction along the plurality of longitudinally extending gaps 150 in a first accordion-like manner. The support body 110 is also configured to contemporaneously fold in a longitudinal direction along the plurality of laterally extending gaps 154 in the first accordion-like manner. Similarly, the support body 104 is configured to fold in a lateral direction along the plurality of longitudinally extending gaps 160 of the substrate array 106 in a second accordion-like manner. The support body 104 is also configured to contemporaneously fold in a longitudinal direction along the plurality of laterally extending gaps 162 of the substrate array 106 in the second accordion-like manner. This arrangement and cooperation between the substrate arrays 106, 108 allows the collapsible partition 100 to contract both laterally and longitudinally when the support bodies 104, 110 contemporaneously fold in both the lateral direction and the longitudinal direction. The arrangement and cooperation between the substrate arrays 106, 108 also allows the collapsible partition 100 to extend both laterally and longitudinally when the support bodies 104, 110 contemporaneously unfold in both the lateral direction and the longitudinal direction.

Referring again to FIG. 11, the partition 100 can be manufactured by initially fabricating two subassemblies: a first subassembly including the decorative body 102, the support body 104, and the substrate array 106; and a second subassembly including the decorative body 112, the support body 110, and the substrate array 108. The first subassembly can be maintained in a flat and unfolded state and otherwise prepared for attachment with the second subassembly. As described above, the second subassembly must be initially folded in at least one dimension by the desired amount to achieve the correct configuration that corresponds to the initial arrangement for the partition 100. The second subassembly (while maintained in its initially folded state) is coupled to the first subassembly (in its unfolded/flat state). In accordance with certain embodiments, the two subassemblies are attached to each other around the perimeter of the partition 100. This allows the majority of the two subassemblies to independently fold relative to each other, and facilitates separation of the two subassemblies in response to the folding and buckling action. The two subassemblies can be coupled together in any suitable manner, e.g., sewing, bonding, tacking, stitching, fasteners, hook and loop elements, snaps, buttons, or the like. In certain embodiments, the two subassemblies can be coupled together at points or locations other than the perimeter or near the edges. Moreover, the subassemblies can be coupled together at any number of points in a way that accommodates a limited amount of separation between the subassemblies, e.g., using a short length of thread or a flexible attachment mechanism.

The exemplary embodiment of the partition 100 described above contemplates the use of primary substrates 140 and secondary substrates 144 throughout the area (or most of the area) defined by the partition 100. In an alternative embodiment, the substrates 140, 144 need not fully span the area of the partition. Instead, the substrates 140, 144 can be arranged only at or near the perimeter of the partition. For example, if the partition will be deployed as a horizontally opening/closing door, then the substrates 140, 144 will be arranged at or near the vertical edges of the partition, and need not be arranged along the horizontal edges or in the main central area of the partition. Conversely, if the partition will be deployed as a vertically opening/closing shade, screen, or wall, then the substrates 140, 144 will be arranged at or near the horizontal edges of the partition, and need not be arranged along the vertical edges or in the main central area of the partition. For such embodiments, the support bodies that carry the substrates 140, 144 can be scored, perforated, pre-folded, or otherwise trained to make the partition naturally fold in an effective and predictable manner.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A collapsible partition comprising:
a first body comprising a foldable material, the first body having an inward-facing side and an outward-facing side, the first body having a planar configuration when unfolded;
a first substrate array comprising a plurality of primary substrates, each primary substrate having a flat geometric shape and being resistant to folding, and each primary substrate coupled to the inward-facing side of the first body;
a second body comprising a foldable material, the second body having an inward-facing side and an outward-facing side, the second body having a planar configuration when unfolded; and
a second substrate array coupled to the first substrate array and comprising a plurality of secondary substrates, each secondary substrate having a flat geometric shape and being resistant to folding, each secondary substrate coupled to the inward-facing side of the second body;
wherein compression of the first substrate array or the second substrate array in a longitudinal or lateral dimension causes the first substrate array to fold between at least some of the plurality of primary substrates, and contemporaneously causes the second substrate array to fold between at least some of the plurality of secondary substrates.

2. The collapsible partition of claim 1, wherein:
the flat geometric shape of the primary substrates is a first rhomboid shape;
the flat geometric shape of the secondary substrates is a second rhomboid shape; and
the first and second rhomboid shapes are different.

3. The collapsible partition of claim 2, wherein:
the first rhomboid shape defines a first area;
the second rhomboid shape defines a second area; and
the first area is greater than the second area.

4. The collapsible partition of claim 2, wherein:
the first rhomboid shape has a first long edge length and a first short edge length;
the second rhomboid shape has a second long edge length and a second short edge length; and
the first long edge length is equal to the second long edge length.

5. The collapsible partition of claim 1, wherein the first and second substrate arrays are coupled together in an initial arrangement such that:
the first substrate array is compressed in a longitudinal dimension and/or in a lateral dimension, with the plurality of primary substrates defining an initially folded state for the first substrate array; and
the second substrate array is uncompressed, with the plurality of secondary substrates defining an unfolded state for the second substrate array.

6. The collapsible partition of claim 5, wherein:
the first substrate array includes longitudinally extending gaps defined between adjacent columns of the primary substrates, and includes laterally extending gaps defined between adjacent rows of the primary substrates;
the second substrate array includes longitudinally extending gaps defined between adjacent columns of the secondary substrates, and includes laterally extending gaps defined between adjacent rows of the secondary substrates; and
when the first and second substrate arrays are in the initial arrangement and viewed from a plan view perspective, the longitudinally extending gaps of the first substrate array align with the longitudinally extending gaps of the second substrate array, and the laterally extending gaps of the first substrate array align with the laterally extending gaps of the second substrate array.

7. The collapsible partition of claim 1, wherein:
the primary substrates are arranged in a first repeating pattern defining a plurality of first columns and a plurality of first rows, each first column being spaced apart from each neighboring first column to define a plurality of first longitudinally extending gaps between first columns, and each first row being spaced apart from each neighboring first row to define a plurality of first laterally extending gaps between first rows; and
the secondary substrates are arranged in a second repeating pattern defining a plurality of second columns and a plurality of second rows, each second column being spaced apart from each neighboring second column to define a plurality of second longitudinally extending gaps between second columns, and each second row being spaced apart from each neighboring second row to define a plurality of second laterally extending gaps between second rows.

8. The collapsible partition of claim 7, wherein:
the first body is configured to fold in a lateral direction along the plurality of first longitudinally extending gaps in a first accordion-like manner and to contemporaneously fold in a longitudinal direction along the plurality of first laterally extending gaps between first rows in the first accordion-like manner;
the second body is configured to fold in a lateral direction along the plurality of second longitudinally extending gaps in a second accordion-like manner and to contemporaneously fold in a longitudinal direction along the plurality of second laterally extending gaps between second rows in the second accordion-like manner;
the collapsible partition contracts both laterally and longitudinally when the first and second bodies contemporaneously fold in both the lateral direction and the longitudinal direction; and
the collapsible partition extends both laterally and longitudinally when the first and second bodies contemporaneously unfold in both the lateral direction and the longitudinal direction.

9. The collapsible partition of claim 7, wherein:
the first repeating pattern defines a first chevron pattern; and
the second repeating pattern defines a second chevron pattern.

10. The collapsible partition of claim 1, wherein:
each primary substrate is adhered to the inward-facing side of the first body; and
each secondary substrate is adhered to the inward-facing side of the second body.

11. The collapsible partition of claim 1, wherein:
the primary substrates are identically shaped and sized; and
the secondary substrates are identically shaped and sized.

12. The collapsible partition of claim 1, further comprising:
a third body comprising a decorative, foldable material, the third body having an inward-facing side coupled to the outward-facing side of the first body; and
a fourth body comprising a decorative, foldable material, the fourth body having an inward-facing side coupled to the outward-facing side of the second body.

13. The collapsible partition of claim 12, wherein:
the third body has an outward-facing side that serves as a first outer surface of the collapsible partition;
the fourth body has an outward-facing side that serves as a second outer surface of the collapsible partition.

14. A collapsible partition comprising:
a first body comprising a foldable material, the first body having an inward-facing side and an outward-facing side, the first body having a planar configuration when unfolded;
a first substrate array comprising a plurality of primary substrates, each primary substrate having a flat geometric shape and being resistant to folding, and each primary substrate coupled to the inward-facing side of the first body;
a second body comprising a foldable material, the second body having an inward-facing side and an outward-facing side, the second body having a planar configuration when unfolded; and
a second substrate array coupled to the first substrate array and comprising a plurality of secondary substrates, each secondary substrate having a flat geometric shape and being resistant to folding, each secondary substrate coupled to the inward-facing side of the second body;
wherein the first and second substrate arrays are coupled together in an initial arrangement such that:
the first substrate array is compressed in a longitudinal dimension and/or in a lateral dimension, with the plurality of primary substrates defining an initially folded state for the first substrate array; and
the second substrate array is uncompressed, with the plurality of secondary substrates defining an unfolded state for the second substrate array.

15. The collapsible partition of claim 14, wherein:
the flat geometric shape of the primary substrates is a first rhomboid shape;
the flat geometric shape of the secondary substrates is a second rhomboid shape; and
the first and second rhomboid shapes are different.

16. The collapsible partition of claim 15, wherein:
the first rhomboid shape has a first long edge length and a first short edge length;
the second rhomboid shape has a second long edge length and a second short edge length; and
the first long edge length is equal to the second long edge length.

17. The collapsible partition of claim 14, wherein:
the first substrate array includes longitudinally extending gaps defined between adjacent columns of the primary substrates, and includes laterally extending gaps defined between adjacent rows of the primary substrates;
the second substrate array includes longitudinally extending gaps defined between adjacent columns of the secondary substrates, and includes laterally extending gaps defined between adjacent rows of the secondary substrates; and
when the first and second substrate arrays are in the initial arrangement and viewed from a plan view perspective, the longitudinally extending gaps of the first substrate array align with the longitudinally extending gaps of the second substrate array, and the laterally extending gaps of the first substrate array align with the laterally extending gaps of the second substrate array.

18. The collapsible partition of claim 14, wherein compression of the first substrate array or the second substrate array in a longitudinal or lateral dimension causes the first substrate array to fold between at least some of the plurality of primary substrates, and contemporaneously causes the second substrate array to fold between at least some of the plurality of secondary substrates.

19. The collapsible partition of claim 14, wherein:
the primary substrates are arranged in a first repeating pattern of chevrons; and
the secondary substrates are arranged in a second repeating pattern of chevrons.

20. The collapsible partition of claim 14, wherein:
the plurality of primary substrates are identically shaped and sized; and
the plurality of secondary substrates are identically shaped and sized.
